(19) United States
(12) Patent Application Publication
(10) Pub. No.: US 2024/0084641 A1
(43) Pub. Date: Mar. 14, 2024

(54) DECORATIVE WINDOW COVERING SYSTEM

(71) Applicant: Selenia Genao, West Babylon, NY (US)

(72) Inventor: Selenia Genao, West Babylon, NY (US)

(21) Appl. No.: 17/767,460

(22) PCT Filed: Oct. 8, 2020
(86) PCT No.: PCT/US20/54717

§ 371 Date: Apr. 8, 2022

Related U.S. Application Data
(60) Provisional application No. 62/912,731, filed on Oct. 9, 2019.

(51) Int. Cl. E06B 3/30

(52) U.S. Cl. CPC E06B 3/30

(57) ABSTRACT

A window covering system includes a window mount and board members. The window mount includes elongated tracks that extend along a window system. The window mount includes tethers coupled to the tracks to temporarily secure the window mount to the window system. The board members have inner and outer surfaces. The outer surface resembles a piece of wood. The inner surface is attachable to the tracks to position the board member in a transverse orientation relative to the tracks. The transverse orientation of the board members is adjustable between different angles relative to the elongated tracks.

### CROSS REFERENCE TO RELATED APPLICATIONS

This application claims priority to PCT Application No. PCT/US20/54717 filed Oct. 8, 2020 which claims the benefit of U.S. Provisional Patent Application No. 62/912,731, filed Oct. 9, 2019, the entire contents of which are incorporated by reference herein.

### TECHNICAL FIELD

This disclosure relates to window coverings and, more particularly, to decorative window coverings configured for seasonal or holiday display.

### BACKGROUND

During a holiday or a holiday season it has become customary to display certain holiday or seasonal ornamentations around a building or a house to add to the holiday or season. In particular, it is known to display pennants, banners, or other decorative displays that include a holiday scene, emblem, logo, or image. For example, a flag having a shamrock for St. Patrick's Day or a pumpkin for Halloween are often displayed during their respective holiday seasons. Although such items are festive, special mounting devices are required to position or hold these displays during use. Such devices are often installed or permanently affixed to, for instance, a wall, a door, or a post.

### SUMMARY

According to one aspect of the disclosure, a decorative window covering system includes a window mount and a plurality of board members. The window mount includes a first elongated track and a second elongated track that are positioned to extend along a window system of a building for decorating the building. The window mount further includes one or more tethers coupled to the first and second elongated tracks and extending therefrom. The one or more tethers receivable between a window and a window frame of the window system to temporarily secure the window mount to the window system and to maintain the first and second elongated tracks vertically oriented along the window system. Each board member of the plurality of board members has an inner surface and an outer surface. The outer surface resembles a piece of wood. The inner surface is selectively attachable to the first and second elongated tracks to position the respective board member in a transverse orientation relative to the first and second elongated tracks. The transverse orientation of each board member of the plurality of board members is selectively adjustable between a plurality of different angles relative to the first and second elongated tracks to change an appearance of the decorative window covering system.

In aspects, the first and second elongated tracks may include a first mechanical fastening structure and each board of the plurality of board members may include a second mechanical fastening structure that couples to the first mechanical fastening structure to secure the plurality of board members to the first and second elongated tracks. The first mechanical fastening structure and the second mechanical fastening structure may include hook and loop material.

In aspects, the one or more tethers includes a plurality of tethers. The plurality of tethers may include a first tether coupled to a top portion of the first and second tracks and a second tether coupled to a bottom portion of the first and second tracks.

In aspects, the tether may be a single unitary tether that extends from top and bottom ends of the first and second tracks.

In aspects, at least one board member of the plurality of board members may be movable between extended and retracted positions to change a length of the at least one board member.

In aspects, the inner surface of at least one board member of the plurality of board members may include a first mechanical fastening portion and a second mechanical fastening portion. The first mechanical fastening portion may be configured to secure to the first elongated track and the second mechanical fastening portion may be configured to secure to the second elongated track. At least one of the first and second mechanical fastening portions may include hook and loop material. The inner surface of each board member of the plurality of board members may include the first mechanical fastening portion and the second mechanical fastening portion. The first mechanical fastening portion and the second mechanical fastening portion may be separate and discrete from one another.

In aspects, the first and second elongate tracks may each have a rectangular configuration.

According to yet another aspect of this disclosure, a decorative window covering system includes a window mount and a plurality of board members. The window mount includes at least one elongated track positioned to extend along a window system of a building for decorating the building. The window mount further includes at least one tether coupled to the at least one elongated track and extending therefrom. The at least one tether is receivable between a window and a window frame of the window system to temporarily secure the window mount to the window system and to maintain the at least one elongated track vertically oriented along the window system. Each board member of the plurality of board members has an inner surface and an outer surface. The outer surface resembles a piece of wood. The inner surface is selectively attachable to the at least one elongated track to position the respective board member in a transverse orientation relative to the at least one elongated track. The transverse orientation of each board member of the plurality of board members is selectively adjustable between a plurality of different angles relative to the at least one elongated track to change an appearance of the decorative window covering system.

In aspects, the at least one elongated track may include a first mechanical fastening structure and each board of the plurality of board members may include a second mechanical fastening structure that couples to the first mechanical fastening structure to secure each board of the plurality of board members to the at least one elongated track. The first mechanical fastening structure and the second mechanical fastening structure may include hook and loop material.

In aspects, the at least one tether may include a plurality of tethers. The plurality of tethers may include a first tether coupled to a top portion of the at least one elongated track and a second tether coupled to a bottom portion of the at least one elongated track.

In aspects, the at least one tether may be a single unitary tether that extends from top and bottom ends of the at least one elongated track.

In aspects, at least one board member of the plurality of board members may be movable between extended and retracted positions to change a length of the at least one board member.

According to yet another aspect of this disclosure, a method of securing a decorative window covering system to a window system of a building is provided. The method includes securing at least one tether of a window mount between a window frame and a window of the window system to temporarily support elongated tracks of the window mount vertically along the window. The method further includes, with hook and loop material, removably attaching a plurality of plastic board members to the elongated tracks of the window mount transverse to the elongated tracks so that the plurality of board members are arranged on the window system to decorate the window system as a boarded up window, wherein the plurality of plastic board members have an outer surface that resembles wood.

Other aspects, features, and advantages will be apparent from the description, the drawings, and the claims that follow.

### BRIEF DESCRIPTION OF THE DRAWINGS

The accompanying drawings, which are incorporated in and constitute a part of this specification, illustrate aspects of the disclosure and, together with a general description of the disclosure given above, and the detailed description of the aspect(s) given below, serve to explain the principles of the disclosure, wherein:

FIG. 1 is a top view, with parts separated, of a decorative window covering system including a window mount and a plurality of board members in accordance with the principles of this disclosure;

FIG. 1A is a cross-sectional view of a portion of the window mount of FIG. 1 as taken along section line 1A-1A shown in FIG. 1;

FIG. 2 is a rear view of one board member of the plurality of board members of the decorative window covering system of FIG. 1;

FIGS. 3A-3C are progressive views illustrating the window mount of the decorative window covering system of FIG. 1 being secured to a window system of a building;

FIGS. 4A and 4B are progressive views of another board member being moved between different positions;

FIG. 4C is an enlarged, cross-sectional view of the board member of FIGS. 4A and 4B as taken along section line 4C-4C shown in FIG. 4B;

FIG. 5 is a perspective view of the decorative window covering system of FIG. 1 shown mounted on a first window system in a first configuration; and

FIG. 6 is a perspective view of the decorative window covering system of FIG. 1 shown mounted on a second window system in a second configuration.

### DETAILED DESCRIPTION

Aspects of the disclosed decorative window covering system are described in detail with reference to the drawings, in which like reference numerals designate identical or corresponding elements in each of the several views. In addition, directional terms such as front, rear, upper, lower, top, bottom, and the like are used simply for convenience of description and are not intended to limit the disclosure attached hereto.

In the following description, well-known functions or constructions are not described in detail to avoid obscuring the present disclosure in unnecessary detail.

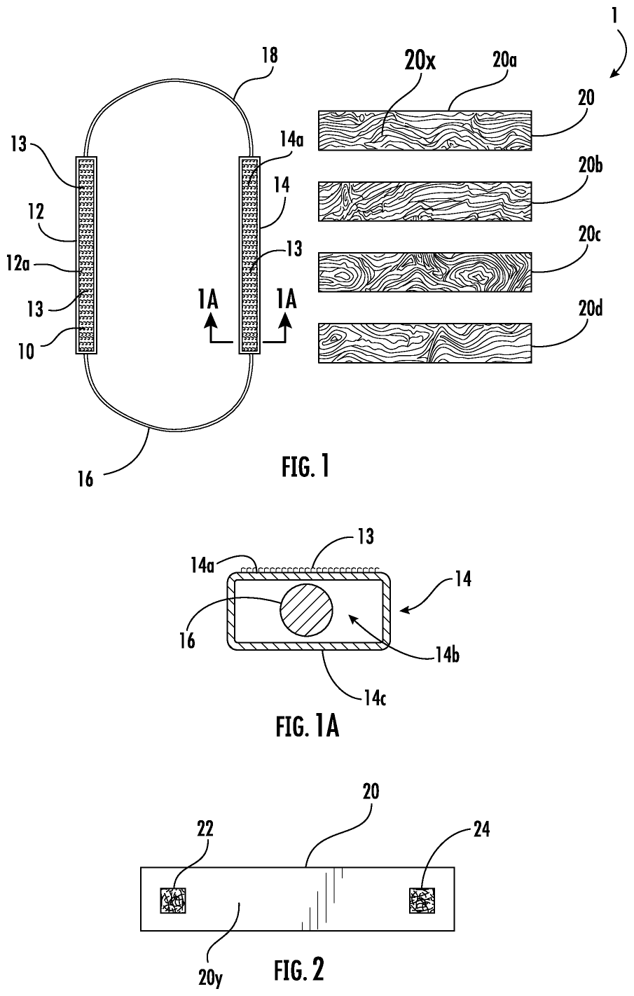

With reference to FIGS. 1, 1A and 2, this disclosure relates to a decorative window covering system 1 including a window mount 10 and a plurality of board members 20 that are selectively attachable to window mount 10. Window mount 10 includes a first track 12 and a second track 14 with any suitable decorative façade having any suitable decorative images and/or colors (e.g., brown, black, etc.) to help portray a holiday theme (e.g., Halloween) and/or to blend in with building structure such as a window frame. First and second tracks 12, 14 have an elongate arrangement, which may be in the form of a rectangular or oblong strip that extends along the length of a window (e.g., at least a majority of the length of a standard house window, namely 24 inch, 36 inch, 48 inch, and/or 60 inch long windows, although the tracks 12, 14 may be provided in any suitable length). First and second tracks 12, 14 may include mechanical fastening structure 13 along the length (or width) thereof for joining objects together. The mechanical fastening structure 13 may be disposed on front or outward-facing surfaces 12a, 14a of first and second tracks 12, 14. For instance, the mechanical fastening structure 13 may include for example, permanent and/or temporary fasteners, hook and loop material, joints, locks, buckles, buttons, flanges, latches, pegs, zippers, straps, anchors, rivet, snaps, magnets, detents, claps, posts, pins, clips, clamps, couplers, adhesive, hooks, ties (string, rope, chain, cable, etc.), or the like. Such mechanical fastening structure 13 may be disposed at any suitable location (length and/or width) along first and second tracks 12, 14, such as, for instance, at spaced-apart, random, predetermined and/or contiguous locations.

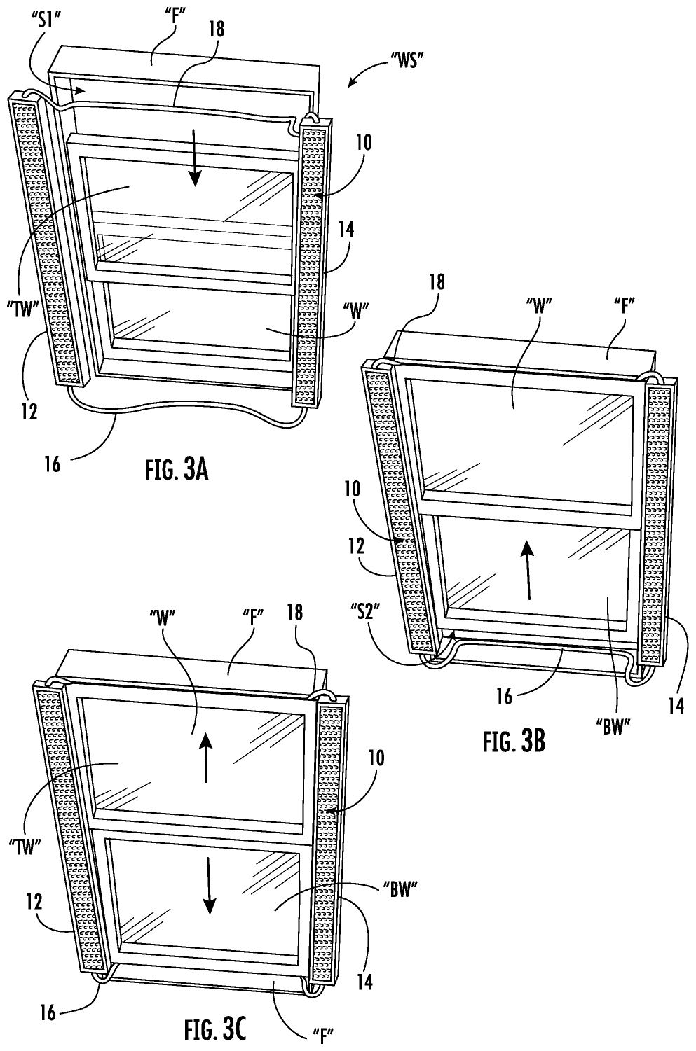

Referring also to FIGS. 3A-3C, window mount 10 of decorative window covering system 1 further includes a first tether 16 (or a first portion of first tether 16) extending from a first end of first and second tracks 12, 14 and a second tether 18 (or a second portion of first tether 16) extending from a second end of first and second tracks 12, 14. First and second tethers 16, 18 are configured to be captured by top and/or bottom portions of a frame “F” of a window “W” to secure tracks 12, 14 to window “W.” First and second tethers 16, 18 can be one or more tethers which may be a unitary tether and/or separate and distinct tethers. In aspects, first and/or second tethers 16, 18 can be thread through first and/or second tracks 12, 14 (e.g., through one or more conduits 14b extending through first and/or second tracks 12, 14—see FIG. 1A). In some aspects, first and/or second tethers 16, 18 can be coupled to a rear or inward-facing surface 14c of first and/or second tracks 12, 14 using any suitable fastening technique (e.g., adhesive, stitching, clips, etc.). In aspects, the conduits 14b may be defined by one or more fasteners (e.g., straps, clips, hooks, etc.—not shown) extending from a rear surface of first and/or second tracks 12, 14 to secure tether(s) 16, 18 to first and/or second tracks 12, 14. First and/or second tethers 16, 18 can include any suitable natural and/or synthetic material such as a polymer, yarn, fabric, metal, ceramic, composite, etc., or combinations thereof, which may be formed using any suitable technique. In some embodiments, first and/or second tethers 16, 18 can include any number of filaments that may be braided and/or woven together. In certain embodiments, tethers 16, 18 can include any flexible (e.g., stretchable, bendable, etc.) and/or semi-flexible material. In certain aspects, tethers 16, 18 may be rigid or semi-rigid and/or may have a L-shaped configuration. In some aspects, tethers 16, 18 may be in the form of one or more separate hooks or hangers.

In some embodiments, first and second tracks 12, 14 may include any suitable mechanical fastener (not shown) extending from, for example, rear surface 14c thereof to secure first and/or second tracks 12, 14 to window “W.” For instance, mechanical fasteners can include suction cups, adhesive, hook and loop, tacks, etc. for securing first and second tracks 12, 14 to window “W,” window frame “F,” and/or part of a building such as siding, etc. (not shown).

With reference again to FIGS. 1 and 2, board members 20 of decorative window covering system 1 can include any number of board members such as board members 20a-20d. The board members 20 can be elongated and have any suitable shape (e.g., rectangular). Board members 20 can include any suitable natural and/or synthetic material, which may include wood, metal, ceramic, and/or polymeric material. A front surface of each board member 20 can include a decorative face 20x resembling a wood surface with any number and/or orientation of grains, knots, and/or rot, and/or other indicia, logos (e.g., skulls), characters/writing (e.g., “keep out”), and/or images (e.g., rusty or bent nails), etc. As seen in FIG. 2, each board member 20 can include a first mechanical fastening portion 22 supported on a first side of a back or rear surface 20y of board member and a second mechanical fastening portion 24 supported on a second side of the back surface 20y thereof so that first mechanical fastening portion 22 can couple to mechanical fastening structure 13 of first track 12 and second mechanical fastening portion 24 can couple to mechanical fastening structure 13 of second track 14. Similar to mechanical fastening structure 13, first and second mechanical fastening portions 22, 24 may include for example, permanent and/or temporary fasteners, hook and loop material, joints, locks, buckles, buttons, flanges, latches, pegs, zippers, straps, anchors, rivet, snaps, magnets, detents, claps, posts, pins, clips, clamps, couplers, adhesive, hooks, ties (string, rope, chain, cable, etc.), or the like for securing to and mechanically cooperating with mechanical fastening structure 13 of first and second tracks 12, 14. First and second fastening portions 22, 24 may be a single unitary structure or strip that extends along a portion and/or at least a majority of the length of the back surface of the respective first and/or second tracks 12, 14, and may extend along any suitable width thereof and in any suitable orientation relative to a longitudinal axis of the respective first and/or second tracks 12, 14.

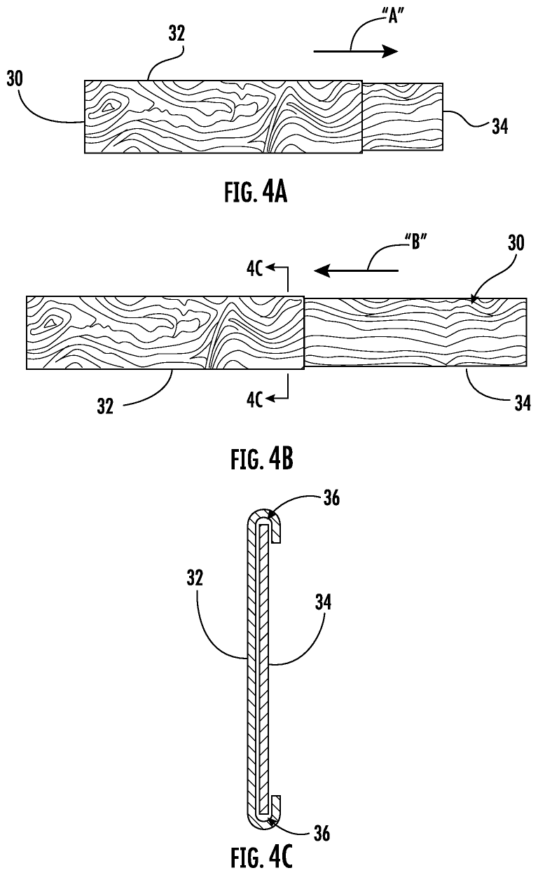

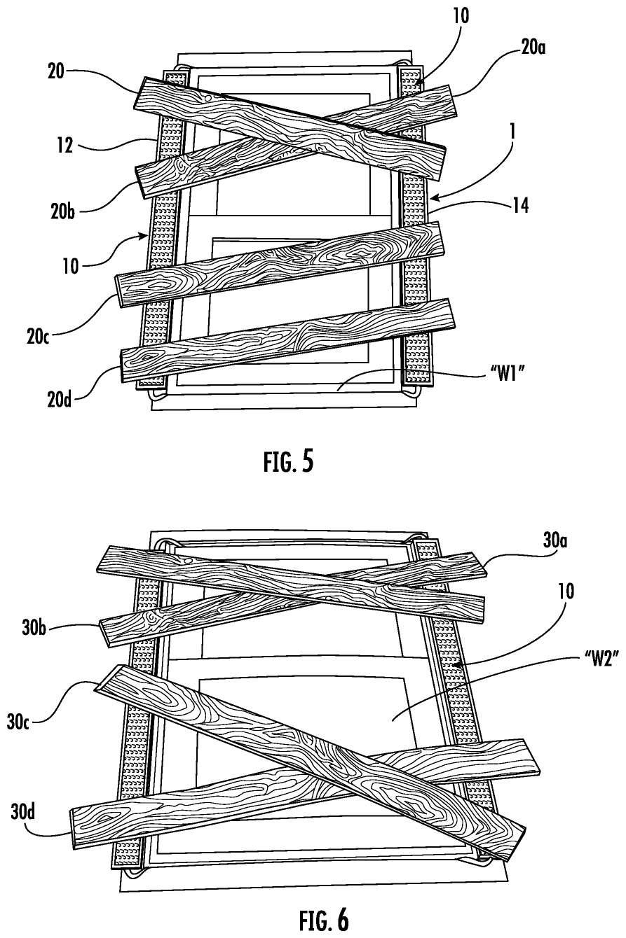

As seen in FIGS. 4A-4C, another embodiment of a board member 30 can include a first portion 32 and a second portion 34 that are slidably coupled together (e.g., telescopically with one received in a channel 36 defined along a back side of another), as indicated by arrows “A” and “B” to selectively change a length of the board member 30. For example, with reference to FIGS. 5 and 6, to accommodate different window dimensions (e.g., first window “W1” having first dimensions and/or second window “W2” having second dimensions that are different than the dimensions of first window “W1”) and/or to provide one or more of the board members 30 (e.g., board members 30a-30d) in different configurations and/or angles relative to the first and second tracks 12, 14 of window mount 10 as illustrated in FIGS. 5 and 6, board members 30 can be adjusted as desired.

In use, for example, in a slider window system “WS” as shown, for instance in FIGS. 3A-3C to secure decorative window covering system 1 thereto, a top window “TW” of the slider window system “WS” is slid down to open a top receiving space “S1” for receiving second tether 18. Second tether 18 is then pulled through the receiving space “S1” so that the top window “TW” can be slid up to secure or capture the second tether 18 between the top window “TW” and the window frame “F” of the slider window system “WS.” Similarly, the bottom window “BW” can be slid up to open a receiving space “S2” below the bottom window “BW,” through which the first tether 16 can be drawn so that when the bottom window “BW” is closed thereafter, the bottom window “BW” captures the first tether 16 between the bottom window “BW” and the window frame “F.” With the first and second tethers 16, 18 secured between the top and bottom windows “TW”, “BW” and the window frame “F” of the slider window system “WS,” the first and second tracks 12, 14 are secured vertically and substantially flush to the windows/window frame of the slider window system “WS.” Board members 20 of decorative window covering system 1 can be secured to first and second tracks 12, 14, as described above and seen in FIGS. 5 and 6, before and/or after the tethers 16, 18 are captured by the slider window system “WS.” In this regard, board members 20 can be disposed across the top and/or bottom windows “TW”, “BW” at any suitable angle (e.g., acute) or relationship (e.g., parallel) relative to one another to create the decorative effect of a boarded up window without actually “boarding up the window” in the traditional sense as a blockade for protecting the window glass or serving as a barrier when no glass is present. Further, this decorative window covering system 1 advantageously enables a user to quickly and easily decorate their windows without damaging the building structure by applying any screw, nail, or other fastener through any wall structure of the building, and without the arduous task of nailing boards to the wall structure, particularly to upper floor windows which would require boards to be hauled up and down a ladder and nailed thereon. Further, the board members 20 can be repeatedly adjusted with ease as desired, compared to traditional boarding up of a window with wood, which would require repeated nailing and removal, a hammer, a ladder, etc. Indeed, nailing and/or screwing wood to building to “board up” a window requires damaging the wood and/or building with the hammer, nail, and/or screw. By comparison, the decorative window covering system 1 of this disclosure enables a user to repeatedly secure and unsecure and/or adjust the decorative window covering system 1 without damaging the decorative window covering system 1, the building, and/or the window system to which it secures for exhibiting, for instance, as a Halloween decoration.

Further, removal of the decorative window covering system 1 is as simple as opening the windows and drawing the decorative window covering system 1 therethrough.

Persons skilled in the art will understand that the structures and methods specifically described herein and shown in the accompanying figures are non-limiting exemplary aspects, and that the description, disclosure, and figures should be construed merely as exemplary of particular aspects. It is to be understood, therefore, that the present disclosure is not limited to the precise aspects described, and that various other changes and modifications may be effected by one skilled in the art without departing from the scope or spirit of the disclosure. Additionally, the elements and features shown or described in connection with certain aspects may be combined with the elements and features of certain other aspects without departing from the scope of the present disclosure, and that such modifications and variations are also included within the scope of the present disclosure. Accordingly, the subject matter of the present disclosure is not limited by what has been particularly shown and described.

What is claimed is:

1. A decorative window covering system comprising:
a window mount including a first elongated track and a second elongated track that are positioned to extend along a window system of a building for decorating the building, the window mount further including at least one tether coupled to the first and second elongated tracks and extending therefrom, the at least one tether receivable between a window and a window frame of the window system to temporarily secure the window mount to the window system and to maintain the first and second elongated tracks vertically oriented along the window system; and
a plurality of board members, each board member of the plurality of board members has an inner surface and an outer surface, the outer surface resembling a piece of wood, the inner surface being selectively attachable to the first and second elongated tracks to position the respective board member in a transverse orientation relative to the first and second elongated tracks, the transverse orientation of each board member of the plurality of board members being selectively adjustable between a plurality of different angles relative to the first and second elongated tracks to change an appearance of the decorative window covering system.

2. The decorative window covering system of claim 1, wherein the first and second elongated tracks include a first mechanical fastening structure and each board of the plurality of board members includes a second mechanical fastening structure that couples to the first mechanical fastening structure to secure the plurality of board members to the first and second elongated tracks.

3. The decorative window covering system of claim 2, wherein the first mechanical fastening structure and the second mechanical fastening structure include hook and loop material.

4. The decorative window covering system of claim 1, wherein the at least one tether includes a plurality of tethers.

5. The decorative window covering system of claim 4, wherein the plurality of tethers includes a first tether coupled to a top portion of the first and second tracks and a second tether coupled to a bottom portion of the first and second tracks.

6. The decorative window covering system of claim 1, wherein the at least one tether is a single unitary tether that extends from top and bottom ends of the first and second tracks.

7. The decorative window covering system of claim 1, wherein at least one board member of the plurality of board members is movable between extended and retracted positions to change a length of the at least one board member.

8. The decorative window covering system of claim 1, wherein the inner surface of at least one board member of the plurality of board members includes a first mechanical fastening portion and a second mechanical fastening portion, the first mechanical fastening portion configured to secure to the first elongated track and the second mechanical fastening portion configured to secure to the second elongated track.

9. The decorative window covering system of claim 8, wherein at least one of the first and second mechanical fastening portions include hook and loop material.

10. The decorative window covering system of claim 8, wherein the inner surface of each board member of the plurality of board members includes the first mechanical fastening portion and the second mechanical fastening portion.

11. The decorative window covering system of claim 10, wherein the first mechanical fastening portion and the second mechanical fastening portion are separate and discrete from one another.

12. The decorative window covering system of claim 1, wherein the first and second elongate tracks each have a rectangular configuration.

13. A decorative window covering system comprising:
a window mount including at least one elongated track positioned to extend along a window system of a building for decorating the building, the window mount further including at least one tether coupled to the at least one elongated track and extending therefrom, the at least one tether receivable between a window and a window frame of the window system to temporarily secure the window mount to the window system and to maintain the at least one elongated track vertically oriented along the window system; and
a plurality of board members, each board member of the plurality of board members has an inner surface and an outer surface, the outer surface resembling a piece of wood, the inner surface being selectively attachable to the at least one elongated track to position the respective board member in a transverse orientation relative to the at least one elongated track, the transverse orientation of each board member of the plurality of board members being selectively adjustable between a plurality of different angles relative to the at least one elongated track to change an appearance of the decorative window covering system.

14. The decorative window covering system of claim 13, wherein the at least one elongated track includes a first mechanical fastening structure and each board of the plurality of board members includes a second mechanical fastening structure that couples to the first mechanical fastening structure to secure each board of the plurality of board members to the at least one elongated track.

15. The decorative window covering system of claim 14, wherein the first mechanical fastening structure and the second mechanical fastening structure include hook and loop material.

16. The decorative window covering system of claim 13, wherein the at least one tether includes a plurality of tethers.

17. The decorative window covering system of claim 16, wherein the plurality of tethers includes a first tether coupled to a top portion of the at least one elongated track and a second tether coupled to a bottom portion of the at least one elongated track.

18. The decorative window covering system of claim 13, wherein the at least one tether is a single unitary tether that extends from top and bottom ends of the at least one elongated track.

19. The decorative window covering system of claim 13, wherein at least one board member of the plurality of board members is movable between extended and retracted positions to change a length of the at least one board member.

20. A method of securing a decorative window covering system to a window system of a building, the method comprising:
securing at least one tether of a window mount between a window frame and a window of the window system to temporarily support elongated tracks of the window mount vertically along the window; and
with hook and loop material, removably attaching a plurality of plastic board members to the elongated tracks of the window mount transverse to the elongated tracks so that the plurality of board members are arranged on the window system to decorate the window system as a boarded up window, wherein the plurality of plastic board members have an outer surface that resembles wood.
